(19) United States
(12) Patent Application Publication
(10) Pub. No.: US 2012/0037245 A1
(43) Pub. Date: Feb. 16, 2012

(54) SWIVEL CONNECTOR FOR A FLUID HANDLING SYSTEM

(75) Inventors: Craig D. Eley, Lincoln, NE (US); Darin Schollmeyer, Lincoln, NE (US)

(73) Assignee: Eley Corporation, Lincoln, NE (US)

(21) Appl. No.: 13/210,128

(22) Filed: Aug. 15, 2011

Related U.S. Application Data
(60) Provisional application No. 61/373,445, filed on Aug. 13, 2010.

(51) Int. Cl. B65H 75/34; F16L 27/00

(52) U.S. Cl. 137/355.26; 285/276

(57) ABSTRACT

A swivel connector of the present technology includes a housing that is rotatably coupled with a rotor, whereby an open fluid pathway extends through the housing and rotor. A rotary union bushing is coaxially, rotatably coupled with an exterior surface of the rotor. A rotor cap is coaxially, rotatably coupled around a length of the rotor; whereby at least a portion of the rotary union bushing is disposed within an interior portion of the rotor cap. A bearing assembly is coupled with the exterior surface of the rotor and at least one of the rotary union bushing or the rotor cap. An O-ring seal may be positioned between the housing and the exterior surface of the rotor to further limit the passage of fluid from the fluid pathway to the interior portion of the rotor cap.

### BACKGROUND

Reels are commonly used to wind fluid delivery lines, such as hoses, that are used in a number of operations that involve fluid handling. Examples of the type of fluids that may need to be handled include water, lubricants, solvents, coolants, and various gases. The reels used in such operations typically employ the use of a swivel for connecting a fluid supply line to the fluid service line, which is wound around the reel. The swivel allows for the winding and unwinding of the service line, not only for ease in using and storing the service line, but also to prevent damage to the same.

Reels are typically supported on axles that further serve as a means to allow the rotation of the reel by the user. While the reel is rotating, the axle is kept in a stationary position. Similarly, the fluid source line, which extends from a fluid source such as a water faucet, must be kept in a stationary position to prevent the twisting or damaging of the line. The swivel allows the connection between the stationary fluid source line and the rotating fluid service line. However, current swivel connectors are either a complex assembly of intricate parts, which increase associated costs and maintenance issues, or made from inferior designs that are limited in use and require frequent repair. Leaking swivels has become a common problem in the hose and reel industry; ranking among the top complaints by users of inferior designs.

In many prior art swivel designs, the rotor and housing rotate with respect to one another in a less than accurate fashion. Frequently, there is a fair amount of concentric play between the rotor and the housing, which is a significant contributor to leaks. In an attempt to provide a swivel that does not leak, various prior art designs increase the pressure on the O-ring seals within the swivel assembly. One problem with this design approach, however, is that the increased pressure on the O-rings also increases the torque required to rotate the swivel. This oftentimes causes premature wear on the O-rings, which can shorten the life of the swivel and cause premature leaking; the very condition the design sought to avoid. Moreover, such increased torque in prior designs can cause the user's hose to kink.

Prior swivel designs are also difficult to repair when the O-rings fail. Conventional designs are meant to be replaced when the O-ring seals fail. This may happen routinely, increasing the operational costs to the user. If prior swivel designs are able to receive replacement O-ring seals, their design limitations require the disruption of the bearing raceway as the housing of the swivel is removed to gain access to the damaged O-ring. This is a fairly complicated repair in the field and may cause more problems than it resolves.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

A swivel connector of the present technology is provided for use within a wide array of fluid handling systems that may incorporate the use of a reel, axle, fluid source line, and fluid delivery line. Generally, the swivel connector will include an elongated rotor, having open end portions and an open fluid pathway extending therebetween. A housing, having open end portions and an open fluid pathway extending between the end portions. The housing is placed in open fluid communication with one end portion of the rotor, such that the housing may freely rotate with respect to the rotor on a common axis.

In various embodiments, a rotary union bushing is provided, having an open end portions. The rotary union bushing is shaped to be coaxially, rotatably coupled with an exterior surface of the rotor. In some embodiments, a rotor cap is associated with the swivel connector and shaped to have open end portions and an open interior portion extending therebetween. The rotor cap is coaxially, rotatably coupled around a length of the rotor. One end portion of the rotor cap may be coupled with an end portion of the housing. In this manner, the rotary union bushing, the rotor cap, and the housing are selectively rotatable about a common axis with respect to the rotor. To facilitate the rotation of the housing, with respect to the rotor, a plurality of bearings are disposed within a raceway that is at least partially defined by a recess formed in the exterior surface of the rotor. The remainder of the raceway may be defined by portions of either or both of the rotary union bushing or the rotor cap.

In various embodiments, an O-ring seal is positioned between the housing and the exterior surface of the rotor, such that the passage of fluid from the fluid pathway of the rotor to the interior portion of the rotor cap is substantially prevented. In some embodiments, a locking O-ring is positioned between the housing and the rotor cap, whereby relative movement between the housing and the rotor cap is substantially prevented.

In various embodiments, the swivel connector is used with reel assemblies of various designs. In many such embodiments, however, the reel assemblies will be configured to support one or more lengths of generally flexible fluid delivery lines. It is contemplated that the reel assemblies will include a line support section or hub that extends between opposite ends of the reel assembly. Some reel assemblies may include a pair of opposing flanges and that project outwardly from the opposing ends of the reel assembly, to form an annular channel for receiving a length of the fluid delivery line. The reel assembly will commonly include an axle that is provided to extend coaxially with the hub and be operatively coupled with the hub such that selective rotation of the hub about the axle is allowed. In some embodiments, the swivel connector may include an axle cap having an open end portions and an open interior extending therebetween. The axle cap may be positioned around the exterior surface of the rotor and secured with an end portion of the axle to secure the swivel connector in a static position with respect to the axel. One end portion of a fluid delivery line is coupled with the terminal end of the housing and the remainder of the fluid delivery line is coiled about the hub. In some embodiments, the fluid delivery line may be anchored to the hub using a hose clamp.

These and other aspects of the present system and method will be apparent after consideration of the Detailed Description and Figures herein.

### DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 depicts a front, perspective view of one embodiment of the swivel connector of the present technology.

FIG. 2 depicts a side elevation, cutaway view of the swivel connector depicted in FIG. 1.

FIG. 3 depicts an exploded perspective view of the swivel connector depicted in FIG. 1.

FIG. 4 depicts a side elevation, cutaway view of the swivel connector depicted in FIG. 1 and depicts one manner in which the swivel connector could be coupled with a reel assembly.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

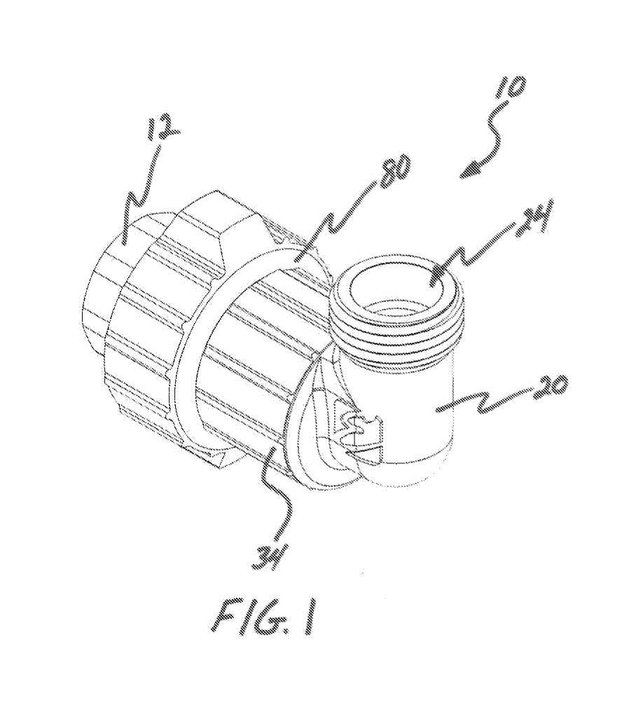

With reference to FIGS. 1-4, a swivel connector 10 of the present technology may be used within a wide array of fluid handling systems that may incorporate the use of a reel, axle, fluid source line, and fluid delivery line. It is contemplated that the fluid handling system may be used in various operations that involve the handling of water, lubricants, adhesives, coolants, solvents, various gases, and other similar fluids. It will be understood by those skilled in the art that, as the application of the system is changed for the handling of different fluids, the materials used, such as the nature and grade of fluid lines used, will change accordingly. However, for purposes of description only, the fluid handling system and the swivel connector 10, more specifically, will be described as it would be used for the handling of water in a residential application.

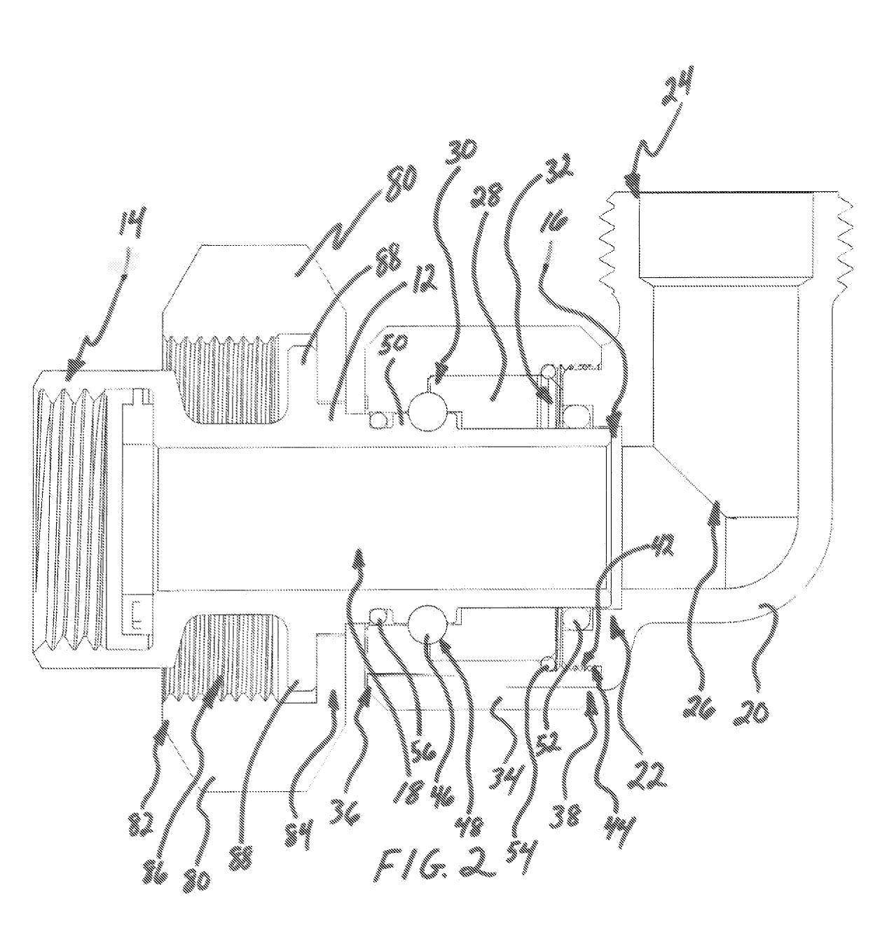

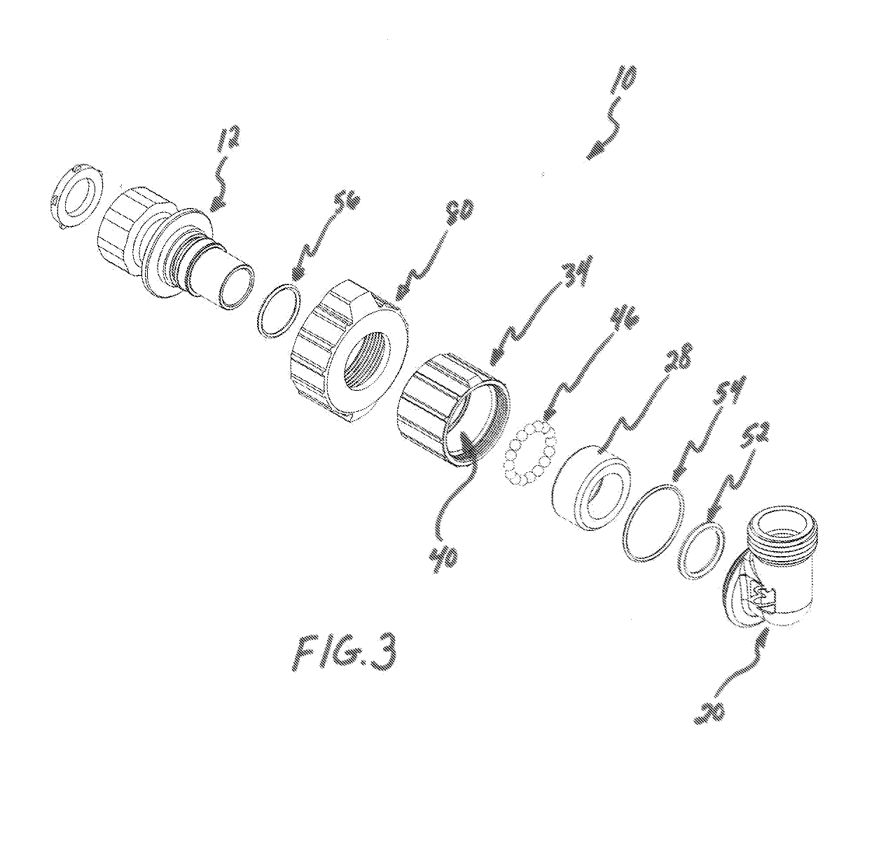

With reference to FIGS. 2 and 3, the swivel connector 10 will include an elongated rotor 12, having an open first end portion 14 and an open second end portion 16. An open fluid pathway 18 extends between the first end portion 14 and the second end portion 16. The swivel connector 10 will further include a housing 20, having an open first end portion 22 and an open second end portion 24. An open fluid pathway 26 extends between the first end portion 22 and the second end portion 24. The first end portion 22 of the housing 20 is placed in open fluid communication with the second end portion 16 of the rotor 12, whereby the open fluid pathway 18 of the rotor 12 is in open fluid communication with the fluid pathway 26 of the housing 20. The second end portion 16 of the rotor 12 and the first end portion 22 of the housing 20 will be positioned so that the housing 20 may freely rotate with respect to the rotor 12 on a common axis extending through a length of the rotor 12.

In various embodiments, the swivel connector 10 will include a rotary union bushing 28, having an open first end portion 30 and an open second end portion 32. The rotary union bushing 28 is shaped to be coaxially, rotatably coupled with an exterior surface of the rotor 12 between the first end portion 14 and the second end portion 16. While it is contemplated that the rotary union bushing 28 may be formed from a wide array of materials, that include various polymers and metals, some embodiments of the present technology form the rotary union bushing 28 from polytetrafluoroethylene (PTFE) or similar materials that may be desirable for their ability to rotatably seal against opposing surfaces, such as the exterior surface of the rotor 12, without undue wear or degradation over a significant lifetime of use. In various embodiments, a rotor cap 34 is associated with the swivel connector 10. The rotor cap 34 will be shaped to have an open first end portion 36 and an open second end portion 38, with an open interior portion 40 extending therebetween. The rotor cap 34 is coaxially, rotatably coupled around a length of the rotor 12. In some embodiments, at least a portion of the rotary union bushing 28 is disposed within the interior portion 40 of the rotor cap 34. With reference to FIG. 2, the second end portion 38 of the rotor cap 34 may be coupled with the first end portion 22 of the housing 20. In some embodiments, the second end portion 38 of the rotor cap 34 may be provided with mating threads 42 along an interior circumference. Mating threads 44 may likewise be formed along an exterior circumference of the first end portion 22 of the housing 20, whereby the housing 20 and the rotor cap 34 may be threadably coupled with one another. In this manner, the rotary union bushing 28, the rotor cap 34, and the housing 20 are selectively rotatable about a common axis with respect to the rotor 12. To facilitate the rotation of the housing 20, with respect to the rotor 12, a plurality of bearings 46 are coupled with the exterior surface of the rotor 12 and at least one of the rotary union bushing 28 or the rotor cap 34. In some embodiments, a raceway 48 is at least partially defined by a recess formed in the exterior surface of the rotor 12. The remainder of the raceway 48 may be defined by portions of either or both of the rotary union bushing 28 or the rotor cap 34. With reference to FIG. 2, a first half of the raceway 48 may be defined by a channel formed in the exterior surface of the rotor 12. In some embodiments, the exterior surface of the rotor 12 may be provided with a ridge 50 that extends radially outward from the exterior surface of the rotor 12. In this manner, the raceway may be partially formed into the ridge 50 without intruding into the fluid pathway 18 of the rotor 12. Similarly, grooves may be formed within either or both of the rotary union bushing 28 and the rotor cap 34. With reference to FIG. 2, some embodiments may form a groove within the first end portion of the rotary union bushing 28 and a mirroring portion of the first end portion 36 of the rotor cap 34. In this manner, the two grooves associated with the rotary union bushing 28 and the rotor cap 34 define the opposing half of the raceway 48. In such embodiments, assembly of the thrust bearing is made easier due to the fact that the raceway 48 is divided between the rotor 12, the rotary union bushing 28, and the rotor cap 34. This allows the assembly of the bearings 46 without an interrupting feature being formed in the raceway 48. Previous designs of swivel connectors have required a cross-hole drilled into the raceway 48 to permit the installation of the bearings 46. Moreover, the multi-component nature of the raceway 48 allows the swivel connector 10 to be repaired more easily to the extent that the raceway 48 may be easily dismantled.

While it is contemplated that the bearings 46 could be made from several different materials, such as hardened or stainless steel, some embodiments of the present technology form the bearings 46 from a plastic, such as Acetyl. The use of Acetyl bearings allows for a higher rate of rotation between the rotor 12 and the opposing structures, such as the rotary union bushing 28 and the rotor cap 34. The Acetyl bearings also tend to wear longer than their steel counterparts. The low coefficient of friction associated with materials such as Acetyl are lower than steel bearings. Accordingly, the Acetyl bearings may rub against one another with a lower instance of disintegration, unlike steel balls. The design of the previously described raceway 48 and bearings 46 need only to provide for axial load and not radial load. Prior swivel connector designs used the bearings within the assembly for both axial and radial loads. The high precision machining required for such an arrangement is obviated by the present design. The rotary union bushing 28 supplies the radial load so that the bearings 46 can fit more loosely within the raceway 48 and not effect the sealing nature of any O-rings disposed within the swivel connector 10.

In various embodiments, an O-ring seal 52 is positioned between the housing 20 and the exterior surface of the rotor 12, whereby the passage of fluid from the fluid pathway 18 of the rotor 12 to the interior portion 40 of the rotor cap 34 is substantially prevented. In some embodiments, the O-ring seal 52 is positioned within an annular channel 52 defined by a portion of each'of the rotary union bushing 28, the housing 20, and the exterior surface of the rotor 12. In at least one embodiment, the annular channel is formed primarily within an interior circumference of the first end portion 22 of the housing 20. The exterior surface of the rotor 12 and the first end portion 30 of the rotary union bushing 28 providing bearing and containment walls, accordingly.

In certain embodiments, a locking O-ring 54 is positioned between the housing 20 and the rotor cap 34, whereby relative movement between the housing 20 and the rotor cap 34 is substantially prevented. In at least one embodiment, the locking O-ring 54 is positioned within a space defined by a portion of each of the rotary union bushing 28, the housing 20, and the rotor cap 34.

With reference to FIG. 2, the sealing O-ring 52 and the rotor 12 are held more concentric due to the fact that the rotary union bushing 28 defines one side of the O-ring sealing gland. Traditionally, the O-ring sealing gland is contained completely within the housing of the swivel. The present design allows a rotating surface (in the present depicted design, the rotary union bushing 28) to touch the non-rotating rotor 12. This design reduces the concentric play between the rotor 12 and the housing 20 which contains the sealing O-ring 52. Accordingly, the present design requires less pressure to be applied to the sealing O-ring 52 in order to create a water tight seal. Moreover, the present design allows for relatively quick and easy changing of a damaged sealing O-ring 52 without disturbing the bearings 46. The housing 20, which contains the sealing O-ring 52, may be removed from the swivel connector 10 by decoupling the first end portion 22 of the housing 20 from the second end portion 38 of the rotor cap 34. The sealing O-ring 52 may then be replaced and the housing 20 re-coupled with the rotor cap 34 without disturbing the bearings 46 within the raceway 48. To assist in the manual coupling and decoupling of the housing 20 and the rotor cap 34, knurling or other such surface textures, may be associated with an exterior surface of the rotor cap 34. The right angle bend associated with the second end portion 24 of the housing 20 typically provides a sufficient opposing surface for the user to grip when coupling or decoupling the structures.

It is contemplated that the swivel connector 10 may be used with reel assemblies of a nearly endless number of different designs. Commonly, however, a reel assembly 58 used with the swivel connectors 10 disclosed herein will be configured to support one or more lengths of generally flexible fluid delivery lines 60. Some examples of such fluid delivery lines 60 include hoses designed for the delivery of various gases, such as compressed air and liquids, such as water and other chemical compositions. Accordingly, irrespective of the specific design of the reel assembly 58, it is contemplated that the reel assembly 58 will include a line support section or hub 62 that extends between opposite end portions 64 and 44 of the reel assembly 58. The hub 62 may be shaped as a drum with a partially open or continuous exterior surface 68, which is adapted for supporting a length of the hose 60. Some reel assemblies may include a pair of opposing flanges 70 and 72 that project outwardly from the opposing end portions 64 and 66 of the reel assembly 58, to form an annular channel for receiving a length of the fluid delivery line 60. The reel assembly 58 will commonly include an axle 74, having a first end portion 76 and a second end portion 78, that is provided to extend coaxially with the hub 62 and be operatively coupled with the hub 62 in a manner that permits selective rotation of the hub 62 about the axle 74. Components of applicant's reel assembly, described in U.S. Pat. No. 7,389,790, issued on Jun. 24, 2008, and other currently pending U.S. patent applications, may provide an exemplary embodiment of a reel assembly 58 that may be used with the swivel connector 10 of the present technology.

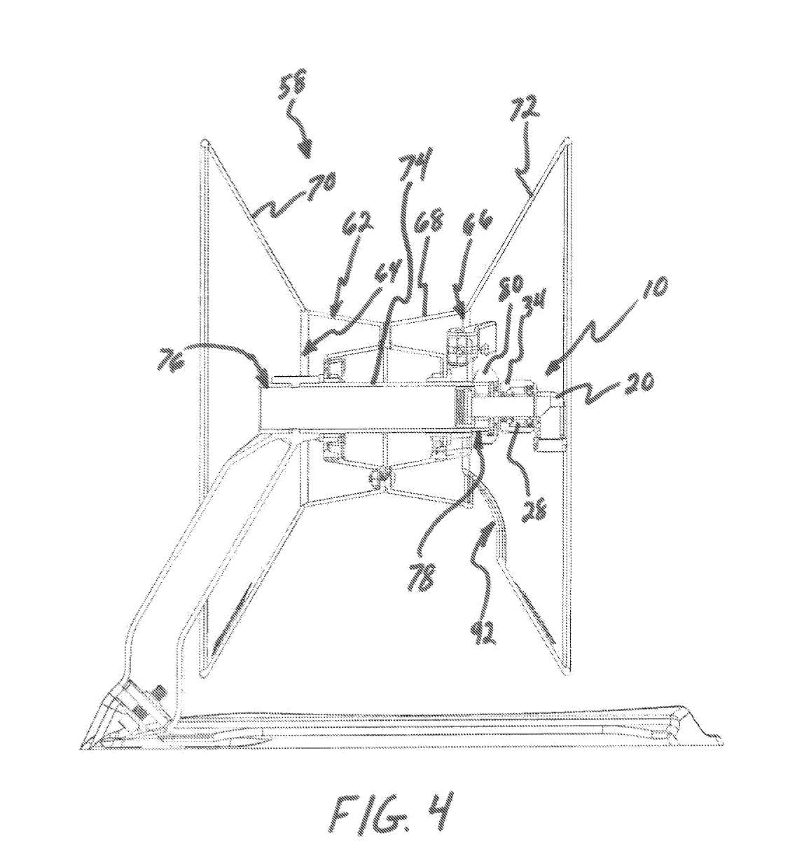

In some embodiments, the swivel connector 10 may be provided with an axle cap 80 having an open first end portion 82, an open second end portion 84, and an open interior portion 86 extending therebetween. The axle cap 80 may be positioned around the exterior surface of the rotor 12 and secured with the second end portion 78 of the axle 74. In this regard, mating threads or other mechanical fastener features may be associated with the interior portion 86 of the axle cap 80 and the second end portion 78 of the axle 74. In some embodiments, an axle cap flange 88 is formed to extend radially outwardly from the exterior surface of the rotor 12, between its first end portion 14 and second end portion 16. With reference to FIG. 4, when the axle cap 80 is coupled with the second end portion 78 of the axle 74, the axle cap flange 88 is disposed between the second end portion 78 of the axle cap 74 and the second end portion 84 of the axle 80. In this manner, the swivel connector 10 may be securely coupled with the axle 74 and, hence, the reel assembly 58. Moreover, in this orientation, the first end portion 14 of the rotor 12 may be coupled with a terminal end portion of a first supply line 90 that extends from a fluid source, such as a faucet, and is at least partially disposed within an open interior portion of the axle 74.

With reference to FIG. 4, the second end portion 24 of the housing may extend freely from a second end portion 66 of the hub 62. In some embodiments, the second end portion 24 of the housing 20 may be disposed at an angle with respect to a long axis of the axle 74. In at least one embodiment, the angle of the second end portion 24 of the housing 20 approximates a 90 degree angle. One end portion of the fluid delivery line 60 may be coupled with the second end portion 24 of the housing 20. A fluid delivery line opening 92 is provided to penetrate the second flange 72, adjacent the hub 62. Once the fluid delivery line 60 is passed through the fluid delivery line opening 92, it may be coiled about the hub 62 in a standard fashion. However, in some embodiments, the fluid delivery line 60 may be anchored to the hub 62 using a hose clamp 94. It is contemplated that the hose clamp 94 may be provided in a variety of different designs that include a loop, which encircles an exterior of the fluid delivery line 60, and a tab or other projection that extends from the loop and is secured with the hub 62 or the flange 72 using a screw or other mechanical fastener. The hose clamp 94 will prevent over stressing of the hardware of the present system, such as the swivel connector 10 when a user attempts to overextend the fluid delivery line 60 from the reel assembly 58.

Although the system and methods of employing the same have been described in language that is specific to certain structures, materials, and methodological steps, it is to be understood that the invention defined in the appended claims is not necessarily limited to the specific structures, materials, and/or steps described. Rather, the specific aspects and steps are described as forms of implementing the claimed invention. Since many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. A swivel for connecting fluid lines in a fluid handling system, the swivel comprising:
an elongated rotor having an open first end portion, an open second end portion and an open fluid pathway extending between the first and second end portions;
a housing having an open first end portion, an open second end portion, and a fluid pathway extending between the first and second end portions; the first end portion of the housing being in open fluid communication with the second end portion of the rotor, whereby the open fluid pathway of the rotor is in open fluid communication with the housing;
a rotary union bushing having an open first end portion and an open second end portion; the rotary union bushing being coaxially, rotatably coupled with an exterior surface of the rotor between the first and second end portions of the rotor;
a rotor cap having an open first end portion, an open second end portion, and an open interior portion; the rotor cap being coaxially, rotatably coupled around a length of the rotor; at least a portion of the rotary union bushing being disposed within the interior portion of the rotor cap; the second end portion of the rotor cap being operatively coupled with the housing; the rotary union bushing, the rotor cap, and the housing being selectively rotatable about a common axis with respect to the rotor; and
a bearing assembly operatively coupled with the exterior surface of the rotor and at least one of the rotary union bushing or the rotor cap.

2. The swivel of claim 1 wherein the first end portion of the rotor is provided with mating threads adapted to be operatively connected to a first fluid line in the fluid handling system.

3. The swivel of claim 2 wherein the second end portion of the housing is provided with mating threads adapted to be operatively connected to a second fluid line in the fluid handling system.

4. The swivel of claim 1 wherein the bearing assembly resides within a raceway that is defined by a portion of each of: the exterior surface of the rotor; the rotary union bushing; and the rotor cap.

5. The swivel of claim 1 further comprising a locking O-ring positioned between the housing and the rotor cap, whereby relative movement between the housing and the rotor cap is substantially prevented.

6. The swivel of claim 5 wherein the locking O-ring is positioned within a space defined by a portion of each of: the rotary union bushing; the housing; and the rotor cap.

7. The swivel of claim 1 further comprising an O-ring seal positioned between the housing and the exterior surface of the rotor, whereby the passage of fluid from the fluid pathway of the rotor to the interior portion of the rotor cap is substantially prevented.

8. The swivel of claim 7 wherein the O-ring seal is positioned within a space defined by a portion of each of: the rotary union bushing; the housing; and the exterior surface of the rotor.

9. The swivel of claim 1 further comprising an O-ring dust seal disposed between the exterior surface of the rotor and the first end portion of the rotor cap.

10. The swivel of claim 6 wherein the O-ring dust seal is at least partially disposed within an annular recess formed within the exterior surface of the rotor.

11. A swivel for connecting fluid lines in a fluid handling system, the swivel comprising:
an elongated rotor having an open first end portion, an open second end portion and an open fluid pathway extending between the first and second end portions;
a housing having an open first end portion, an open second end portion, and a fluid pathway extending between the first and second end portions; the first end portion of the housing being in open fluid communication with the second end portion of the rotor, whereby the open fluid pathway of the rotor is in open fluid communication with the housing;
a rotary union bushing having an open first end portion and an open second end portion; the rotary union bushing being coaxially, rotatably coupled with an exterior surface of the rotor between the first and second end portions of the rotor;
a rotor cap having an open first end portion, an open second end portion, and an open interior portion; the rotor cap being coaxially, rotatably coupled around a length of the rotor; at least a portion of the rotary union bushing being disposed within the interior portion of the rotor cap; the second end portion of the rotor cap being operatively coupled with the housing; the rotary union bushing, the rotor cap, and the housing being selectively rotatable about a common axis with respect to the rotor;
an O-ring seal positioned between the housing and the exterior surface of the rotor;
a locking O-ring positioned between the housing and the rotor cap; and
a bearing assembly within a raceway defined by a portion of each of: the exterior surface of the rotor; the rotary union bushing; and the rotor cap.

12. The swivel of claim 11 further comprising:
an O-ring dust seal disposed between the exterior surface of the rotor and the first end portion of the rotor cap;
the O-ring dust seal at least partially disposed within an annular recess formed within the exterior surface of the rotor.

13. A fluid handling system, the system comprising:
a reel assembly having opposite end portions and a line support section located between the opposite end portions; the line support section having a long axis extending through the opposite end portions of the reel assembly;
an axle having an open first end portion, an open second end portion, and a long axis extending through the first and second end portions; the reel assembly being operatively rotatably coupled with the axle, whereby the long axis of the axle is positioned coaxially with the long axis of the support section of the reel assembly;
a swivel, comprising:
an elongated rotor having an open first end portion, an open second end portion and an open fluid pathway extending between the first and second end portions;
a housing having an open first end portion, an open second end portion, and a fluid pathway extending between the first and second end portions; the first end portion of the housing being in open fluid communication with the second end portion of the rotor, whereby the open fluid pathway of the rotor is in open fluid communication with the housing;
a rotary union bushing having an open first end portion and an open second end portion; the rotary union bushing being coaxially, rotatably coupled with an exterior surface of the rotor between the first and second end portions of the rotor;
a rotor cap having an open first end portion, an open second end portion, and an open interior portion; the rotor cap being coaxially, rotatably coupled around a length of the rotor; at least a portion of the rotary union bushing being disposed within the interior portion of the rotor cap; the second end portion of the rotor cap being operatively coupled with the housing; the rotary union bushing, the rotor cap, and the housing being selectively rotatable about a common axis with respect to the rotor;
a bearing assembly operatively coupled with the exterior surface of the rotor and at least one of the rotary union bushing or the rotor cap; and
an axle cap having an open first end portion, an open second end portion, and an open interior; the axle cap positioned around the exterior surface of the rotor and secured with the second end portion of the axle.

14. The fluid handling system of claim 13 wherein the swivel further comprises:
an axle cap flange extending radially outwardly from the exterior surface of the rotor; the axle cap flange being disposed between the second end portion of the axle cap and the second end portion of the axle.

15. The fluid handling system of claim 14 wherein the first end portion of the rotor is coupled with a terminal end portion of a first fluid line; the first fluid line being at least partially disposed within an open interior of the axle.

16. The fluid handling system of claim 15 wherein the second end portion of the housing is coupled with one end portion of a second fluid line; the second fluid line being at least partially supported around the line support section of the reel assembly.

17. The fluid handling system of claim 16 further comprising:
a fluid line retainer loop at least partially disposed around a section of the fluid delivery line supported on the line support section of the reel assembly; the fluid line retainer loop being secured with the line support section of the reel assembly.

18. The fluid handling system of claim 17 wherein the swivel further comprises:
a locking O-ring positioned within a space defined by a portion of each of: the rotary union bushing; the housing; and the rotor cap.

19. The fluid handling system of claim 18 wherein the swivel further comprises:
an O-ring seal positioned within a space defined by a portion of each of: the rotary union bushing; the housing; and the exterior surface of the rotor.

20. The fluid handling system of claim 19 wherein the swivel further comprises:
an O-ring dust seal disposed between the exterior surface of the rotor and the first end portion of the rotor cap; the O-ring dust seal being at least partially disposed within an annular recess formed within the exterior surface of the rotor.
